(19) United States
(12) Patent Application Publication
(10) Pub. No.: US 2008/0181465 A1
(43) Pub. Date: Jul. 31, 2008

(54) APPARATUS AND METHODS FOR IDENTIFYING PATIENTS

(76) Inventor: Jim T. Sauerwein, Charlote, NC (US)

Correspondence Address: HAND HELD PRODUCTS, INC., 700 VISIONS DRIVE, P.O. BOX 208, SKANEATELES FALLS, NY, 13153-0208, US

(21) Appl. No.: 11/669,203

(22) Filed: Jan. 31, 2007

(51) Int. Cl. G06K 9/00

(52) U.S. Cl. 382/115

(57) ABSTRACT

A patient identification system based on a portable data terminal including a biometric data capture device for capturing biometric scan data from a person and creating a biometric template for the person. A reference biometric template is prepared based oil a biometric scan of patient. Software is provided on the portable data terminal to compare the biometric template captured by the portable data terminal to the reference biometric template and indicate a whether the person corresponds to the patient described by the reference biometric template.

### BACKGROUND OF THE INVENTION

Certain organizations, such as hospitals, have a significant interest in ensuring that services are provided to the correct individual. Wristbands are commonly used within a hospital to ensure that patients are correctly identified for medical treatment. Some hospitals print a barcode, unique to the patient, onto the wristband, which may be scanned at the time medication is provided to the patient, either to automatically dispense the proper medication from a cart or to ensure the proper medication container is selected by scanning a similar barcode on that container. The barcodes may be scanned by a portable hand held scanner or with a portable data terminal.

The term portable data terminal (PDT) refers to data collection devices used to collect, process, and transfer data to a larger data processing system. Most PDTs are ruggedized to some extent for use in industrial environments. PDT's are available from several sources, including the assignee of the present application: HAND HELD PRODUCTS, INC.

A PDT generally comprises a mobile computer, a keypad, and a data acquisition device. The mobile computer generally comprises a hand held (or “pocket”) computing device, such as those available from INTEL, PALM, HEWLETT PACKARD, and DELL. Keypads come in a variety of alpha-numeric and numeric configurations. The data acquisition device generally comprises a device that captures data from, for example, radio frequency IDs (RFID), images, and bar codes. Data may also be captured via keypad entry and utilization of a touch pad associated with the mobile computer.

FIG. 1A is an orthogonal view of a known PDT 100. FIG. 1B is a plan view of the known PDT 100. The illustrated example utilizes a popular form factor incorporating a body 102 and a handle 101. The body 102 generally supports a variety of components, including: a battery (not shown but typically located the rear half of the body): an LCD with touch screen 106: a keyboard 108 (including a scan button 108a); a scan engine 110; and a data/charging port 112 (not fully illustrated). The scan engine 110 may comprise, for example, an image engine or a laser engine. The data/charging port 1112 typically comprises a proprietary interface with one set of pins or pads for the transmitting and receiving of data and a second set of pins or pads for receiving power for powering the system and/or charging the battery.

The handle 101, extending from a bottom surface of the body 102, incorporates a trigger 114. In use, the user may actuate either the scan key 108a or the trigger 114 to initiate a frame capture via the image engine 110. The captured frame may either be processed as an image or as a data carrier. In the first case, the captured frame may undergo some post capture image processing, such as de-speckling or sharpening and then stored as an image file (e.g. a bitmap, jpeg of gif file) and possibly displayed. In the second case the captured frame also undergoes some post capture image processing but the image is then analyzed, e.g. decoded, to identify data represented therein. The decoded data is stored and possibly displayed on the PDT 100. Additional processing of the image or data may take place on the PDT 100 and/or a data processing resource to which the data is transmitted via any available transport mechanism on the PDT 100. Some examples of known transport mechanisms utilized by PDT's include: Bluetooth, WiFi, GSM, CDMA, USB, IrDA, removable FLASH memory, parallel and serial ports (including for example, RS-232).

While the use of barcodes on patient Wristbands may reduce, it has not eliminated incorrect identification of patients. Further, the reliability of such barcodes may be conditioned upon the position of the patient at the time of scanning. It is also to be noted that PDT provide a significant amount of processing power that could be used to reduce incorrect identification of patients. Accordingly, the present Inventors have recognized a need for improved identification apparatus and methods for identifying patients.

### BRIEF DESCRIPTION OF THE DRAWINGS

An understanding of the present invention can be gained from the following detailed description of embodiments of the invention taken in conjunction with the accompanying drawings of which:

FIG. 1A is an orthogonal view of a known PDT.

FIG. 1B is a plan view of a known PDT.

FIG. 2 is a block diagram of a PDT in accordance with an embodiment of the present invention.

FIG. 3 is a flow chart of a method that may be utilized by the described embodiments of the present invention.

FIG. 4 is a conceptual screen shot of a user interface that may be utilized in the described embodiments of the present invention.

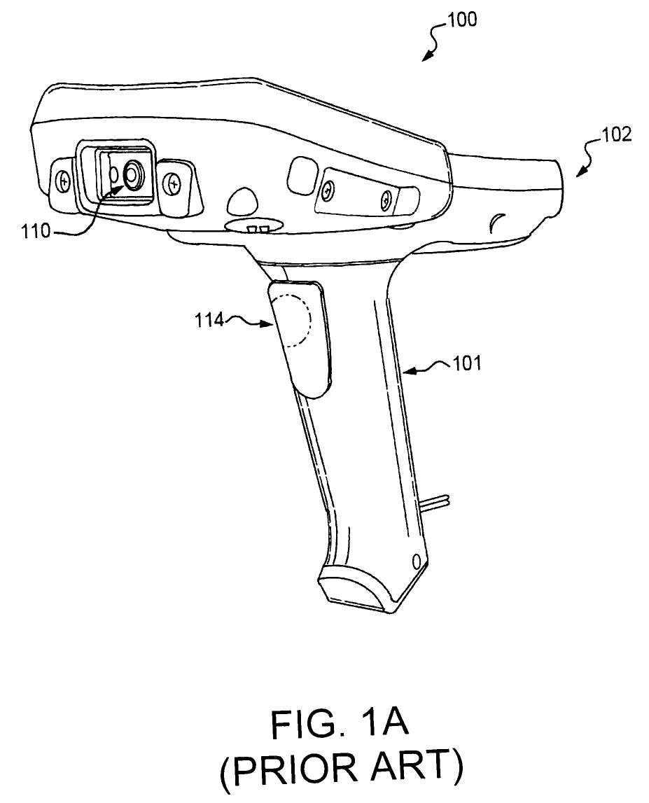

### DETAILED DESCRIPTION

Reference will now be made in detail to the present invention, examples of which are illustrated in the accompanying drawings, wherein like reference numerals refer to like elements throughout. The following description will use nomenclature associated with an imager based PDT, however those of ordinary skill in the art will recognize that the present invention is applicable to a variety of portable devices including RF or magstripe based PDTs, personal data assistants (PDAs): bar code scanners, and consumer electronics, for example digital cameras, cellular phones, and the like. It is anticipated that many such portable devices would benefit from the present invention, including the embodiments thereof described herein.

A method is here, and generally, conceived to be a sequence of steps or actions leading to a desired result and may be implemented as software. While it may prove convenient to discuss such software as if were embodied by a single program, most implementations will distribute the described functions among discrete (and some not so discrete) pieces of software. These pieces are often described using such terms of art as “programs,” “objects,” “functions,” “subroutines,” “libraries,” “.dlls,” “APIs.” and “procedures.” While one or more of these terms may find favor in the present description there is no intention to limit the invention or the described embodiments to the recited configurations.

With respect to the software described herein, those of ordinary skill in the art will recognize that there exist a variety of platforms and languages for creating software for performing the methods outlined herein. Embodiments of the present invention can be implemented using MICROSOFT VISUAL STUDIO or any number of varieties of C. However, those of ordinary skill in the art also recognize that the choice of the exact platform and language is often dictated by the specifics of the actual system constructed, such that what may work for one type of system may not be efficient on another system. It should also be understood that the methods described herein are not limited to being executed as software on a processor or DSP (Digital Signal Processor), but can also be implemented in a hardware processor. For example, the methods could be implemented with HDL (Hardware Design Language) in an ASIC.

In the present description, an element number followed by a letter generally indicates multiple occurrences of similar, either in structure or function, elements. Further, the use of an italicized “n” (e.g. n) associated with an element number generally denotes either an unspecified one of such elements or a partial or complete group of such elements—the meaning of which is to be drawn from the context of such use.

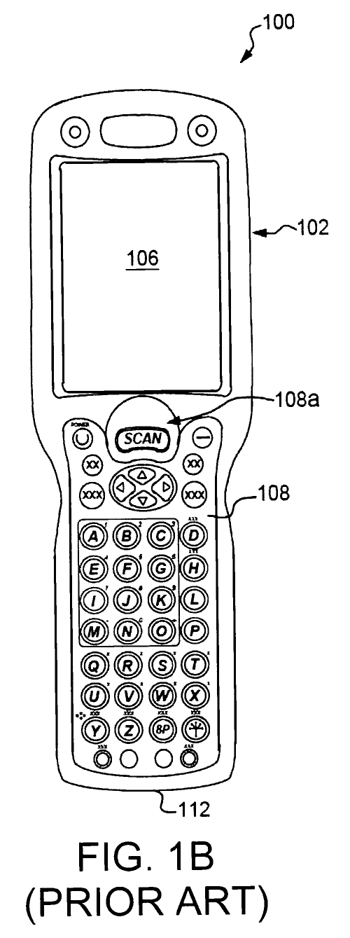

FIG. 2 is a block diagram of a PDT 1000 in accordance with an embodiment of the present invention. Those of ordinary skill in the art will recognize that the illustrated design of the PDT 1000 has been simplified so as to permit a briefer explanation of systems and components not directly related to the present invention.

A central processing unit (CPU) 1010 receives data from and outputs data to other sub-systems for storage, transmission and additional processing. CPU 1010 may be implemented using any number of off the shelf solutions including: embedded processors, such as an XSCALE processor available from INTEL; general purpose processors, such as a PENTIUM 4 available from INTEL; or any number of custom solutions including pre-configured field programmable gate arrays (FPGAs) and application specific integrated circuits (ASICs). Overall operation of the CPU 1010 is controlled by software or firmware, typically referred to as an operating system, stored in one or more memory locations 1017n, including RAM 1017a and FLASH memory 1017b. Examples of suitable operating systems for PDT 1000 include: WINDOWS MOBIL, WINDOWS CE, WINDOWS XP, LINUX, PALM, SYMBIAN, and OSX.

In general, communication to and from the CPU 1010 and the various sub-components takes place via one or more ports or busses, including a main system bus 1012: I²C busses 1013a and 1013b: a plurality of Universal Asynchronous Receivers/Transmitter (UART) ports 1014n, a Universal Serial Bus (USB) 1015n, and an RS-232 port 1016.

The illustrated CPU 1010 also includes a liquid crystal display (LCD) controller 1018 for controlling an LCD 1020. A touch sensitive panel 1021, which may be in communication with one or more of the CPU 1010 and an auxiliary processor 1024 via the I²C bus 1013b, may be associated with the LCD 1020 for receipt of data thereon. The combination of the LCD 1020 and the touch sensitive panel 1021 is often referred to as a “touch screen.”

A variety of secondary (or “sub”) processors may be provided to perform general and application specific functions. The example illustrated in FIG. 2 provides two such processors: a field programmable gate array (FPGA) 1022 and the auxiliary processor 1024. The FPGA 1022 may comprise any number of FPGA including the Virtex-4 family available from XILINX. The auxiliary processor 1024 may comprise any number of embedded (or general purpose) processors, including the PICmicro® family of microcontrollers available from MICROCHIP TECHNOLOGY.

The auxiliary processor 1024 may interface with and control a variety of data input devices including, for example, the touch panel 1021, a keyboard 1034 and a scan button 1036. By way of example the PDT 1000 may be configured so that displayed menu options are selected by physically depressing a key on the keyboard 1034 or activating the touch screen 1021 with use of a finger or stylus. The scan button 1036 may be used for initiating and controlling the various data collection systems, such as an image signal generating system 1028, an RFID sensing system 1030, or a magnetic stripe reader 1040.

The data collection systems (e.g. the image signal generating system 1028, the RFID sensing system 1030, and the magnetic stripe reader 1050) may be controlled by one or more of the CPU 1010, the auxiliary processor 1024, and the FPGA 1022. In this case, the FPGA 1022 initiates and controls the operation of the data collection systems and accumulates data received there from prior to depositing such data in memory 1017n. Possible configurations of FPGA 1022 are illustrated in U.S. Pat. No. 6,947,612 incorporated herein by reference.

The image signal generating system 1028 generally comprises a two dimensional solid state image sensor 1029 utilizing such technologies as CCD, CMOS, and CID, for capturing an image containing data, e.g. a bar code or signature. Two-dimensional solid state image sensors generally have a plurality of photo sensor picture elements (“pixels”) which are formed in a pattern including a plurality of rows and a plurality of columns of pixels. The image signal generating system 1028 further includes an imaging optics (not shown) focusing an image onto an active surface of the image sensor 1029. Image sensor 1029 may be incorporated on an image sensor IC chip having disposed thereon image sensor control circuitry, image signal conditioning circuitry, and an analog-to-digital converter. FPGA 1022 manages the capture and transfer of image data into RAM 1017n. Decoding may be performed by the CPU 1010 or any suitable secondary processor. Examples of devices suitable for use as the imaging assembly 1028 include an IMAGETEAM 5x00VGA/5x00MPX imaging module of the type available from Hand Held Products, assignee of the present application. A variety of alternatives, including dedicated laser barcode scanners may also be utilized.

One use of the image signal generating system 1028 is for reading and interpreting bar codes such as bar code 1051 a on an item 1050. For this operation, when the scan button 1036 is actuated, the CPU 1010 causes the appropriate control signals to be sent to the image sensor 1029. In response thereto, the image sensor 1029 outputs digital image data including (hopefully) an adequate representation of the bar code symbol 1050. The digital image data is streamed to the FPGA 1022 where it is collected and subsequently deposited in memory 1017n. In accordance with a decoding program (not specifically illustrated) an attempt may be made to decode the bar code represented in the captured electronic image representation. The capture and decoding of image data may occur automatically in response to a trigger signal being generated, usually by activation of the scan button 1036 or a pre-selected key on keyboard 1034. For example, the CPU 1010 may be configured, typically through execution of a program resident in memory 1017n, to continuously capture and decode bar code symbols represented therein as long as scan button 1036 is actuated. The cycle may be terminated upon successfully decoding the bar code symbol or by timing out after a number of unsuccessful attempts.

In addition to having a decode operation, the image signal generation system 1028 may also be configured for an image capture operation. In an image capture operation, control circuit 1010 captures an electronic image representation in response to the scan button 1036 being actuated without attempting to decode a decodable symbol represented therein. The captured electronic image representation may be one or more of (i) stored into a designated memory location of memory 1017n, (ii) transmitted to an external spaced apart device, or (iii) displayed on LCD 1020. This mode may be used to capture, for example an image of a signature or damage to a package.

In an image capture operation, the image signal generation system 1028 may be operated in two distinct stages: aiming and final capture. During the aiming stage, frames output by the image signal generation system 1028 are displayed on the LCD display 1020. These frames are not saved. Once a user is satisfied with the content of the image displayed on the LCD display 1020, he or she initiates the final capture stage. In final capture stage, a frame (either the frame currently in the buffer or a next frame) is saved and typically displayed on the LCD 1020. Generally, the aiming stage is initiated by pressing a designated button (such as a scan button 1036) with the final capture stage being initiated by releasing the designated button. It is generally desirable to display frames as quickly as possible in the aiming stage to ensure that the user is viewing a recently outputted fame. Otherwise there is a danger that the frame the user views when deciding to initiate capture is outdated and does not accurately reflect what the image signal generating system 1028 is currently outputting (and what will be captured in final capture stage).

The RFID reader unit 1030 includes an RF oscillation and receiver circuit 1032a and a data decode processing circuit 1032b. RFID reader unit 1030 may be configured to read RF encoded data from a passive RFID tag, such as tag 1051b, which may be disposed on article 1050.

Where the RFID reader unit 1032a is configured to read RF encoded data from a passive RFID tag, the RF oscillation and receiver circuit 1032a transmits a carrier signal to the passive tag which in turn converts the carrier energy to voltage form and actuates a transponder (not shown) to transmit a radio signal representing the encoded tag data. The RF oscillator and receiver circuit 1032a, in turn, receives the radio signal from the tag and converts the data into a digital format. The data decode processing circuit 1032b, typically including a low cost microcontroller IC chip, decodes the received radio signal information received by RF oscillator and receiver circuit 1032a to decode the encoded identification data originally encoded into RFID tag.

RFID reader unit 1030 may, for example, operate in a selective activation mode or in a continuous read operating mode. In a selective activation mode, RFID reader unit 1030 broadcasts radio signals in an attempt to activate a tag or tags in its vicinity in response to an RFID trigger signal being received. In a continuous read mode, RFID reader module 1030 continuously broadcasts radio signals in an attempt to actuate a tag or tags in proximity with unit automatically, without module 1030 receiving a trigger signal. PDT 1000 may be configured so that the CPU 1010 recognizes a trigger signal under numerous conditions, such as: (1) the trigger 1034 is actuated; (2) an RFID trigger instruction is received from a remote device; or (3) the CPU 1010 determines that a predetermined condition has been satisfied.

Still further, the PDT 1000 may include a card reader unit 1040 for reading data from a card 1052. Card reader unit 1040 generally comprises a signal detection circuit 1042a and a data decode circuit 1042b. In operation, the signal detection circuit 1042a detects data from, for example, a magnetic strip 1053 on a card 1052. Subsequently, the data decode circuit 1042b decodes the data. The decoded data may be transmitted to the CPU 1010 for further processing via the FPGA 1022. The card reader unit 1040 can be selected to be of a type that reads card information encoded in more than one data format. For example, the card reader unit 1040 may comprise a Panasonic ZU-9A36CF4 Integrated Smart Reader capable of reading any one of magnetic stripe data, smart card or Integrated circuit card (IC card) data, and RF transmitted data.

A power circuit 1100 supplies power to the PDT 1000. The power circuit 1100 generally comprises a series of power supplies 1102n that regulate the power supplied to the various components of the PDT 1000. The power supplies 1102n each generally comprise step up or step down circuits which are in turn connected to each of the various components in the PDT 1000 that require the particular voltage output by that power supply 11027.

The power supplies receive current from a power bus 1103 which is, in turn, supplied by one of a battery 1104, a first power input 1106 or a connector 1108 that includes a second power input. The first power input 1106 may comprise a DC power jack, for example, a 2.5 mm coaxial DC power plug which receives 9.5 volts from a conventional AC/DC transformer. The connector 1108 may comprise any number of known connection technologies, such as the D Series of circular plastic connectors or the HCL D-sub derivative design data transfer connector available from HYPERTRONICS, INC. Certain pins of the connector 1108 may be dedicated to receiving DC power, for example 9.5 volts, while other pins are dedicated to one or more communication paths, e.g. RS-232 and USB. It may also prove advantageous to provide DC power out, for example from a power supply 1102a, so as to power tethered accessories, such as external magnetic stripe or RFID readers (not shown). It may prove further advantageous to add circuitry to insulate the first power input 1106 from the second power input on the connector 1108 and other components in the PDT 1000 in the event that a user attempts to supply power to both power inputs.

The battery 1104 may be selected from any of a variety of battery technologies including fuel cell, NiMh, NiCd, Li Ion, or Li Polymer. The battery 1104 is charged by a charge circuit 1110 which receives power from either the first power input 1106 or the second power input on the connector 1108. The charge circuit may comprise any of a number of available circuits. In the example shown in FIG. 2, control is provided to the CPU 1016 which may modify the charging behavior of the charge circuit 1110 based on information generated by the auxiliary processor 1024. In this example, the auxiliary processor 1024 monitors battery chemistry, such as gas content, via known interfaces, such as the SMART battery interface as specified by the Smart Battery System Implementers Forum. A switch 1112 isolates the battery based upon the presence of power from the first power input 1106 or the second power input on the connector 1108. Thus, when an external power supply is connected to the power input 1106 or the second power input on the connector 1108, the battery is isolated from the power supplies 1102n and may be charged via the charge circuit 110. Once power is removed from the power input 1106 and the connector 1108, the battery is connected to the power supplies 1102n.

The PDT 1000 may further include a plurality of wireless communication links such as an 802.11 communication link 1260, an 802.16 communication link 1262, a communication link 1264 for communication with a cellular network such as a network in accordance with the Global System for Mobile Communications (GSM), an IR communication link 1268, and a Bluetooth communication link 1270. Each of these links facilitates communication with a remote device and may be used to transfer and receive data.

The PDT 1000 has an associated biometric sensor 2002 to confirm the identity of a patient. The term “biometrics” generally refers to automated methods of recognizing a person based on a physiological or behavioral characteristic. Among the characteristics that may be measured include; facial features, fingerprints, hand geometry, handwriting iris, retinal, vein, and voice. As such, the biometric sensor 2002 may comprise a finger print reader, an infrared imager, a microphone, a DNA analysis unit or a chemical analysis unit. It is to be noted that the image signal generating system 1028 may also be used as a biometric sensor by obtaining images of body parts, e.g. face, ear, retina, hand, profile, etc . . . While not technically under the definitional umbrella of the term, should the patient be implanted with an RFID chip, the RFID reader unit 1030 may be used as a characteristic to identify the patient.

A biometric template generally comprises a digital representation of a patient's distinct characteristics as sensed by the biometric sensor. Biometric templates are formed by transforming the raw output of a sensor using known signal processing techniques which vary depending on the modality of the biometric characteristic sensed. The signal processing techniques may be integrated with the biometric sensor 2002 or may be performed by the CPU 1010 or other processors, such as the auxiliary processor 1024, within the PDT 1000.

Once created, the biometric template is stored in a memory location within the PDT 1000. Depending upon how the template is to be used (registration, verification or identification) the biometric template is subject to additional processing. In the case of registration, wherein the template is to be associated with a particular person, and used for future verification or identification, identification information is associated with the template and the package is stored in a secure location. This location may be a remote system or somehow secured within the PDT 1000. If the template is to be used for verification, the PDT 1000 would pull an identified pre-existing template (perhaps from a remote system) and compare the two templates to verify the claimed identity of the person. If the template is to be used for identification, the newly created template would be compared against a pre-existing set of templates to identify the template (and therefore the corresponding person) that most closely matches the newly created template. In general, most PDTs are capable of performing verification where a single comparison operation is required, but many may prove unacceptably slow for identification where multiple comparison operations are required. As such it may prove beneficial to transmit the template that needs identification to a remote system on which the identification comparison processes are carried out.

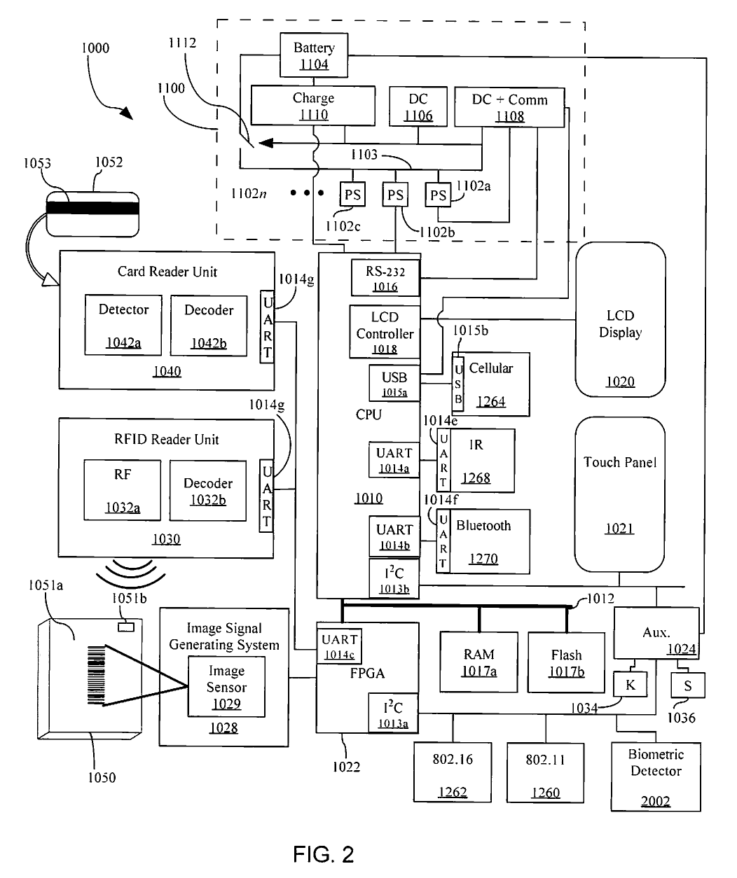

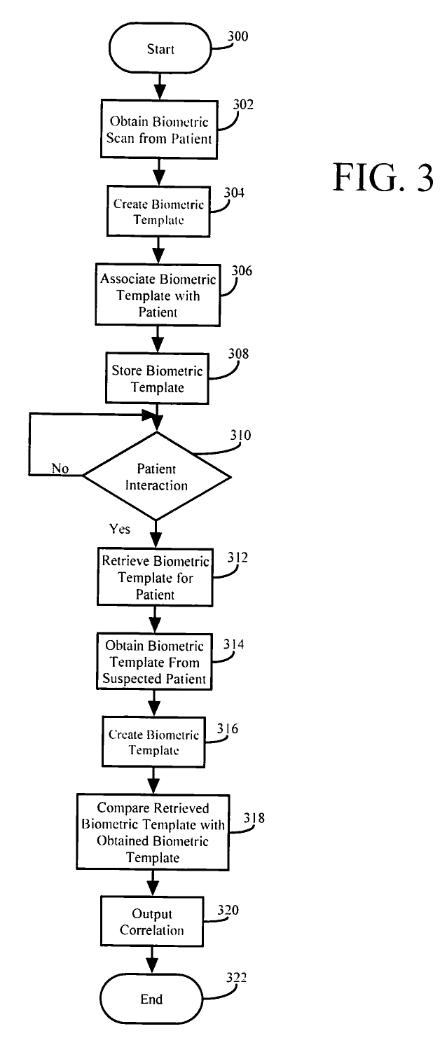

FIG. 3 is a flow chart of a method that may be utilized by the described embodiments of the present invention. The method starts in step 300. In step 302, an initial biometric scan is performed on a patient. The biometric scan may be performed by any capable device, including the biometric sensor 2002 associated with a PDT 1000. Next in step 304, a biometric template is created from the data obtained during the biometric scan. Thereafter in step 306, the biometric template is associated with the patient. This generally comprises data that identifies the biometric template as describing the patient. This may, for example, comprise an entry in the patient's medical records pointing to the biometric template. By way of another example, the identity of the patient may be stored in metadata associated with the biometric template.

Next in step 308, the biometric template is stored in a defined location. The basic requirement for the location is that it be directly or indirectly accessible by the PDT 1000. The location will generally fall into three categories: on the PDT 1000; in a central database; or in a distributed manner.

The biometric data may be stored on any of the fixed or removable memory types available to the PDT 1000, including RAM 1017a, and FLASH memory 1017b. While this solution may be suitable for a limited number of patients, it may not be ideal for a large group. It may prove preferable to either centralize storage or distribute storage of the biometric data while supplying the PDT 1000 with one or more patient's biometric data as needed. The biometric data may be protected by any number of encryption and/or digital rights management schemes.

A central database will generally comprise one or more computers with associated storage. Using one of the several available communication mediums, the PDT 1000 would transmit and receive biometric templates as needed. U.S. Pat. No. 6,820,050, incorporated herein by reference, discloses a system adapted for use in a hospital environment that may be expanded to include the storage and transmission of biometric templates as part of patient data. In particular, the '050 patent discloses a system wherein patient records are retrieved based upon an identity of a logged-in user.

The biometric data may also be stored in a distributed manner, meaning that the biometric data for each patient or group of patients may be stored separately. In one possible configuration, the biometric data for a patient may be stored on a device physically associated with the patient, such as a smart card. As another example, a compact flash memory card, such as an SD or Compact FLASH card, may be created for each patient and stored with the patient's paper records—typically held together by a clip board that may be stored at the nurses station the patient's bed or just outside his room. By way of yet another example, the biometric data may be encoded into a bar code or RFID tag and affixed to the patient's wrist. A suitable bar code system is described in U.S. patent application Ser. No. 11/173,228 filed Jun. 30, 2005, assigned to the assignee of the present application, and incorporated herein by reference. Similarly, a suitable RFID system is described in U.S. patent application Ser. No. 11/565,881 filed Dec. 1, 2006, assigned to the assignee of the present application, and incorporated herein by reference.

After the biometric data is stored (and optionally associated with the patient), the method waits until interaction with a patient is required in step 310. Such interaction may, for example, comprise providing medication, performing a medical procedure, or simply updating the patient's vitals chart. Until verification has been performed the person visually identified as requiring such interaction is the suspected patient.

In step 312, the biometric template for the patient for which verification is required is retrieved and stored on the PDT 1000. The PDT 1000 is then used to obtain biometric scan data directly from the suspected patient in step 314. Thereafter, in step 316, the scanned biometric scan data is used to create a biometric template for the suspected patient. Next in step 318, the biometric template from the suspected patient is compared to biometric template of the patient retrieved in step 312. In 320 a correlation between the two biometric templates is outputted on the PDT 1000's screen. The method ends in step 322.

Once confirmation is made that the suspected patient is, in fact, the patient, the interaction with the patient may proceed. e.g. the medicine dispensed, the procedure undertaken, etc . . . . If the biometric template from the suspected patient does not match the stored biometric template, a variety options are available, including re-scanning the suspected patient and/or refusing to provide the prescribed medical services

Although some embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A patient identification system comprising:
a reference biometric template prepared based on a patient; and
a portable data terminal including a biometric data capture device for capturing biometric scan data from a person and creating a biometric template for the person, the portable data terminal including software to compare the biometric template captured by the portable data terminal to the reference biometric template and indicate a whether the person corresponds to the patient described by the reference biometric template.

2. A patient identification system, as set forth in claim 1, wherein the reference biometric template is stored on a data carrier associated with the patient.

3. A patient identification system, as set forth in claim 2, wherein the data carrier comprises a two dimensional bar code.

4. A patient identification system, as set forth in claim 3, wherein the two dimensional bar code is printed on a wristband.

5. A patient identification system, as set forth in claim 2, wherein the data carrier comprises an RFID tag.

6. A patient identification system, as set forth in claim 5, wherein the RFID tag is attached to a wristband.

7. A patient identification system, as set forth in claim 1, wherein the reference biometric template is based on an image of a physical feature of the patient.

8. A patient identification system, as set forth in claim 7, wherein the reference biometric template is based on at least one of the patient's face, ear, fingerprint. DNA, chemical composition, heat signature, or retina.

9. A patient identification system, as set forth in claim 1, wherein the biometric data capture device comprises an imager.

10. A patient identification system, as set forth in claim 1, wherein the biometric data capture device comprises a fingerprint reader.

11. A method of identifying a patient comprising:
performing a first biometric scan on a patient upon to prior to being admitted to a medical facility;
creating a reference biometric template based on the biometric scan;
associating the biometric template with the patient's medical records;
taking a second biometric scan from a person;
creating a suspected biometric template based on the second biometric scan;
comparing the reference biometric template with the suspected biometric template;
determining whether the person is likely the patient; and
conditioning the provision of medical services to the person based on whether the person is likely the patient.
